(19) United States
(12) Patent Application Publication
(10) Pub. No.: US 2025/0391307 A1
(43) Pub. Date: Dec. 25, 2025

(54) DISPLAY DEVICE, DRIVING METHOD THEREOF, AND ELECTRONIC DEVICE INCLUDING THE SAME

(71) Applicant: SAMSUNG DISPLAY CO., LTD., YONGIN-SI (KR)

(72) Inventor: Yun Ho JANG, Yongin-si (KR)

(21) Appl. No.: 19/208,857

(22) Filed: May 15, 2025

(30) Foreign Application Priority Data
Jun. 20, 2024 (KR) 10-2024-0080187
Jul. 24, 2024 (KR) 10-2024-0097900

(51) Int. Cl. G09G 3/20; G09G 3/3233

(52) U.S. Cl. CPC G09G 3/2007; G09G 3/2096; G09G 3/3233; G09G 2300/0842; G09G 2300/0861; G09G 2310/027; G09G 2310/0286; G09G 2320/0233; G09G 2320/0238; G09G 2320/0673; G09G 2320/0693; G09G 2330/023; G09G 2360/148; G09G 2360/16

(57) ABSTRACT

A display device includes a display unit including pixels, a power supply for generating a gamma power voltage, based on a power control signal, a gamma voltage generator for generating gamma voltages, based on a gamma control signal, and a data driver for generating a data voltage corresponding to a grayscale value included in image data, using the gamma voltages, and providing the data voltage to the pixels. A voltage level of the gamma power voltage varies according to a luminance of an input image corresponding to the image data.

### CROSS-REFERENCE TO RELATED APPLICATION

This patent application claims priority under 35 U.S.C. § 119(a) to Korean patent application Nos. 10-2024-0080187 filed on Jun. 20, 2024 and 10-2024-0097900 filed on Jul. 24, 2024 in the Korean Intellectual Property Office, the disclosures of which are incorporated by reference in their entireties herein.

### 1. Technical Field

The present disclosure is directed to a display device, a driving method thereof, and electronic device including the same.

### 2. Discussion of Related Art

A display device is a connection medium between a user and information. Examples of the display device include a liquid crystal display device, an organic light emitting display device, and an inorganic light emitting display device.

The display device may include a display panel and a driver. The display panel includes scan lines, data lines, and pixels. The driver includes a scan driver which sequentially provides a scan signal to the scan lines and a data driver which provides a data signal to the data lines. Each of the pixels may emit light with a luminance corresponding to the data signal provided through a corresponding data line in response to the scan signal provided through a corresponding scan line.

The data driver may generate gamma voltages corresponding to a plurality of grayscales, and convert a grayscale value of image data into a data signal, using a corresponding one of the gamma voltages. The display device may use a great deal of power based on these gamma voltages. However, if the gamma voltages are lowered to conserve power, it can significantly impact image quality and user experience.

### SUMMARY

Embodiments provide a display device, a driving method thereof, and electronic device including the same in which power consumption can be reduced by varying the magnitude of a voltage applied to a data driver according to a luminance of an input image.

In accordance with an embodiment of the present disclosure, there is provided a display device including: a display unit including pixels; a power supply configured to generate a gamma power voltage, based on a power control signal; a gamma voltage generator configured to generate gamma voltages, based on a gamma control signal; and a data driver configured to generate a data voltage corresponding to a grayscale value included in image data, using the gamma voltages, and provide the data voltage to the pixels, wherein a voltage level of the gamma power voltage varies according to a luminance of an input image corresponding to the image data.

The voltage level of the gamma power voltage may become lower as the luminance of the input image becomes lower.

The display device may further include: a storage device configured to store black data voltage information and white data voltage information for each luminance of the input image; and a timing controller configured to receive, from the storage device, the black data voltage information and the white data voltage information on the luminance of the input image, and generate the power control signal and the gamma control signal.

The power control signal may include the black data voltage information on the luminance and information on a margin value. The power supply may determine the voltage level of the gamma power voltage by adding the margin value to a black data voltage level obtained from the black data voltage information on the luminance.

The gamma power voltage may be a voltage necessary for driving the data driver, and be supplied to the data driver via the gamma voltage generator.

The gamma control signal may include the black data voltage information and the white data voltage information on the luminance. The gamma voltage generator may determine a black data voltage level obtained from the black data voltage information on the luminance as a voltage level of a first gamma voltage among the gamma voltages. The gamma voltage generator may determine a white data voltage level obtained from the white data voltage information on the luminance as a voltage level of a second gamma voltage among the gamma voltages.

The first gamma voltage may correspond to a voltage having a highest voltage level among the gamma voltages, and the second gamma voltage may correspond to a voltage having a lowest voltage level among the gamma voltages. The data voltage may be selected among voltages generated by dividing the gamma voltages.

The data driver may receive, from the storage device, a lookup table including a selection value for calculating a data voltage corresponding to a specific grayscale value, and calculates a voltage level of the data voltage, using the selection value, and wherein, irrespective of variations in the luminance of the input image, the selection value for calculating the data voltage corresponding to the same grayscale value remains unchanged.

The data voltage may become a black data voltage when the selection value is 0, and become a white data voltage when the selection value is 1.

The data voltage may become a black data voltage when the selection value is 1, and become a white data voltage when the selection value is 0.

In accordance with an embodiment of the present disclosure, there is provided a method of driving a display device, the method including: receiving, from a timing controller, black data voltage information and white data voltage information on a luminance of an input image; receiving a lookup table from the timing controller that includes selection values mapped to corresponding grayscales; and calculating a data voltage level, based on the received black data voltage information, the received white data voltage information, and a selection value among the selection values mapped to one of the grayscales of the input image, wherein irrespective of variations in the luminance of the input image, the selection value corresponding to the same grayscale value remains unchanged.

A data voltage generated based on the data voltage level may become a black data voltage when the selection value is 0, and become a white data voltage when the selection value is 1.

A data voltage generated based on the data voltage level may become a black data voltage when the selection value is 1, and become a white data voltage when the selection value is 0.

The display device may include a storage device configured to store black data voltage information and white data voltage information for each luminance of the input image, and the lookup table. The method may further include receiving, by the timing controller, the black data voltage information and the white data voltage information on the luminance of the input image, and the lookup table from the storage device.

The display device may include a power supply configured to generate a gamma power voltage, based on a power control signal generated by the timing controller. A voltage level of the gamma power voltage may vary according to the luminance of the input image.

The voltage level of the gamma power voltage may become lower as the luminance of the input image becomes lower.

In accordance with an embodiment of the present disclosure, there is provided a display device including: a display unit including pixels; a timing controller; and a data driver configured to: receive black data voltage information and white data voltage information corresponding to a luminance of an input image; receive a lookup table from the timing controller including selection values corresponding to respective grayscales; and calculate a data voltage level based on the received black data voltage information, the received white data voltage information, and a selection value from the lookup table corresponding to a grayscale in the input image.

In accordance with an embodiment of the present disclosure, there is provided a electronic device including: a processor to provide input image data; and a display device to display an image based on the input image data, the display device comprising: a display unit including pixels; a power supply configured to generate a gamma power voltage, based on a power control signal; a gamma voltage generator configured to generate gamma voltages, based on a gamma control signal; and a data driver configured to generate a data voltage corresponding to a grayscale value included in image data, using the gamma voltages, and provide the data voltage to the pixels, wherein a voltage level of the gamma power voltage varies according to a luminance of an input image corresponding to the image data.

### BRIEF DESCRIPTION OF THE DRAWINGS

The above and other features of the disclosure will become more apparent by describing in further detail embodiments thereof with reference to the accompanying drawings, in which:

FIG. 1 is a block diagram illustrating a display device in accordance with an embodiment of the present disclosure;

FIG. 2 is a circuit diagram illustrating an example of a pixel included in the display device shown in FIG. 1;

FIG. 3 is a block diagram illustrating a timing controller shown in FIG. 1;

FIGS. 4 and 5 are diagrams illustrating magnitudes of gamma voltages and a gamma power voltage according to a luminance of an input image;

FIG. 6 is a block diagram illustrating a data driver shown in FIG. 1; and

FIG. 7 is a flowchart illustrating a driving method of the display device shown in FIG. 1 according to an example embodiment.

FIG. 8 is a block diagram of an electronic device according to an embodiment.

FIG. 9 shows schematic views of various embodiments of an electronic device.

### DETAILED DESCRIPTION

Hereinafter, embodiments of the present disclosure will be described in more detail with reference to the accompanying drawings. It should be noted that in the following description, only portions necessary for understanding an operation according to the present disclosure are described, and descriptions of other portions may be omitted so as not to obscure subject matter of the present disclosure. In addition, the present disclosure is not limited to exemplary embodiments described herein, but may be embodied in various different forms. The exemplary embodiments herein are described in enough detail to allow those skilled in the art to implement the same.

In the entire specification, when an element is referred to as being “connected” or “coupled” to another element, it can be directly connected or coupled to the another element or be indirectly connected or coupled to the another element with one or more intervening elements interposed therebetween. The technical terms used herein are used only for the purpose of illustrating a specific embodiment and not intended to limit the embodiment. It will be understood that when a component “includes” an element, unless there is another opposite description thereto, it should be understood that the component does not exclude another element but may further include another element. It will be understood that for the purposes of this disclosure, “at least one of X, Y, and Z” can be construed as X only, Y only, Z only, or any combination of two or more items X, Y, and Z (e.g., XYZ, XYY, YZ, ZZ). Similarly, for the purposes of this disclosure, “at least one selected from the group consisting of X, Y, and Z” can be construed as X only, Y only, Z only, or any combination of two or more items X, Y, and Z (e.g., XYZ, XYY, YZ, ZZ).

It will be understood that, although the terms “first”, “second,” etc. may be used herein to describe various elements, these elements should not be limited by these terms. These terms are only used to distinguish one element from another element. Thus, a “first” element discussed below could also be termed a “second” element without departing from the teachings of the present disclosure.

Spatially relative terms, such as “below,” “above,” and the like, may be used herein for ease of description to describe the relationship of one element to another element, as illustrated in the figures. It will be understood that the spatially relative terms, as well as the illustrated configurations, are intended to encompass different orientations of the apparatus in use or operation in addition to the orientations described herein and depicted in the figures. For example, if the apparatus in the figures is turned over, elements described as “below” or “beneath” other elements or features would then be oriented “above” the other elements or features. Thus, the exemplary term, “above,” may encompass both an orientation of above and below. The apparatus may be otherwise oriented (e.g., rotated 90 degrees or at other orientations) and the spatially relative descriptors used herein interpreted accordingly.

In addition, the embodiments of the disclosure are described here with reference to schematic diagrams, which may illustrate ideal embodiments (and an intermediate structure) of the present disclosure. Changes in a shape as shown due to, for example, manufacturing technology and/or a tolerance may be expected. Therefore, the embodiments of the present disclosure are not limited to the specific shapes of a region shown here, but include shape deviations caused by, for example, the manufacturing technology.

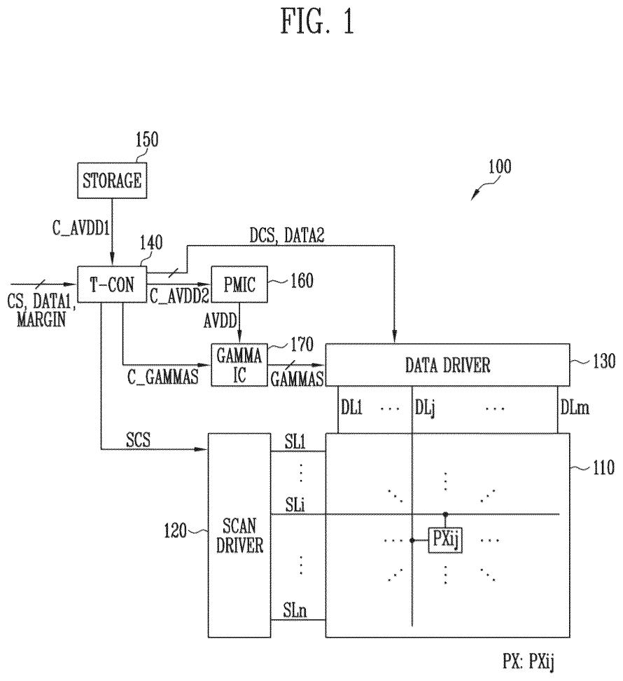

FIG. 1 is a block diagram illustrating a display device in accordance with an embodiment of the present disclosure.

Referring to FIG. 1, the display device 100 includes a display unit 110 (or display panel), a scan driver 120 (or gate driver), a data driver 130 (or source driver), a timing controller 140 (or T-CON), a storage device 150 (or memory device), a power supply 160 (or a power management integrated circuit (PMIC)), and a gamma voltage generator 170 (or gamma integrated circuit (IC)).

The display unit 110 may include scan lines SL1 to SLn (n is a positive integer) (or gate lines), data lines DL1 to DLm (m is a positive integer), and pixels PX. The pixels PX may be disposed in areas (e.g., pixel areas) partitioned by the scan lines SL1 to SLn and the data lines DL1 to DLm, respectively.

Each of the pixels PX may include sub-pixels emitting lights of different colors. For example, a first sub-pixel among the sub-pixels may emit light of a first color (e.g., red). A second sub-pixel among the sub-pixels may emit light of a second color (e.g., green). A third sub-pixel among the sub-pixels may emit light of a third color (e.g., blue).

Each of the pixels PX may be connected to at least one of the scan lines SL1 to SLn and one of the data lines DL1 to DLm. For example, any one pixel PXij among the pixels PX may be connected to an ith scan line SLi and a jth data line DLj (each of i and j is a positive integer).

The pixel PXij may emit light with a luminance corresponding to a data signal provided through a data line (e.g., the jth data line DLj) in response to a scan signal (e.g., a scan signal or a gate signal, which is provided at a current time point) provided through the scan line SLi.

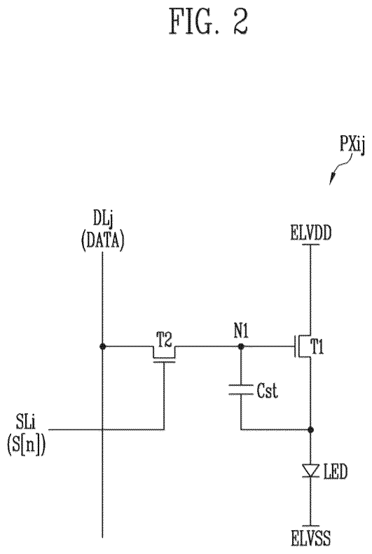

First and second power voltages ELVDD and ELVSS (see FIG. 2) may be provided to the display unit 110. The first and second power voltages ELVDD and ELVSS may be voltages necessary for operations of the pixels PX, and the first power voltage ELVDD may have a voltage level higher than a voltage level of the second power voltage ELVSS. The first and second power voltages ELVDD and ELVSS may be provided to the display unit 110 from a separate power supply or the power supply 160.

The scan driver 120 may generate a scan signal, based on a scan control signal SCS, and sequentially provide the scan signal to the scan lines SL1 to SLn. The scan control signal SCS may include a start signal, clock signals, and the like, and be provided from the timing controller 140. For example, the scan driver 120 may include a shift register (or stage) which sequentially generates and outputs the scan signal in a pulse form, which corresponds to the start signal in a pulse form, using the clock signals.

The data driver 130 may generate data signals (or data voltages), based on image data DATA2 and a data control signal DCS, which are provided from the timing controller 140, and provide the data signals (or data voltages) to the display unit 110 (or the pixels PX). The data control signal DCS may be a signal for controlling an operation of the data driver 130, and include a load signal (or data enable signal) for instructing an output of a valid data signal, and the like.

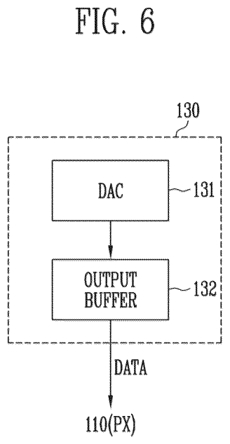

The data driver 130 may generate data signals (or data voltages) DATA (see FIG. 6) corresponding to a grayscale value included in the image data DATA2, using gamma voltages GAMMAS. The gamma voltages GAMMAS may be provided from the gamma voltage generator 170. A more detailed operation of the data driver 130 will be described later with reference to FIG. 6.

The timing controller 140 may receive input image data DATA1 corresponding to an input image from the outside (e.g., a graphic processor). Also, the timing controller 140 may receive a control signal CS, generate the scan control signal SCS and the data control signal DCS, based on the control signal CS, and generate the image data DATA2 by converting the input image data DATA1. The control signal CS may include a vertical synchronization signal, a horizontal synchronization signal, a clock signal, and the like. For example, the timing controller 140 may convert the image data DATA1 in an RGB format into the image data DATA2 in an RGBG format, which accords with a pixel arrangement in the display unit 110.

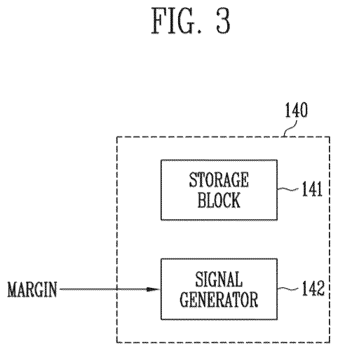

Also, the timing controller 140 may receive information on a margin value MARGIN (see FIG. 3) from the outside. In an embodiment, the margin value MARGIN is used to adjust a voltage level of a gamma power voltage AVDD.

In an embodiment, the timing controller 140 receives a power control signal C_AVDD1 (or first power control signal) from the storage device 150. In an embodiment, the storage device 150 stores black data voltage (or voltage for expressing black) information for each luminance of the input image. Also, the storage device 150 may store white data voltage (or voltage for expressing white) information for each luminance (or brightness) of the input image. For example, the storage device 150 may store black data voltage information on a luminance of an input image corresponding to the input image data DATA1. For example, the storage device 150 may store white data voltage information on the luminance of the input image corresponding to the input image data DATA1. In addition, the timing controller 140 may receive, from the storage device 150, the power control signal C_AVDD1 including the black data voltage information and the white data voltage information, which correspond to the luminance of the input image. For example, voltage levels for the image to express black and white may be different when a luminance of the image changes.

The timing controller 140 may provide the power supply 160 with an adjusted power control signal C_AVDD2 (or second power control signal). The adjusted power control signal C_AVDD2 may include black data voltage information on the luminance of the input image corresponding to the input image data DATA1. Also, the adjusted power control signal C_AVDD2 may include the information on the margin value MARGIN. In an embodiment, the power supply 160 adjusts a voltage level of the gamma power voltage AVDD, using the information included in the adjusted power control signal C_AVDD2. The gamma power voltage AVDD may be a voltage necessary for driving of the data driver 130 or for driving the gamma voltage generator 170.

The timing controller 140 may transfer a gamma control signal C_GAMMAS to the gamma voltage generator 170. The gamma control signal C_GAMMAS may include the black data voltage information and the white data voltage information on the luminance of the input image corresponding to the input image data DATA1. Also, the gamma control signal C_GAMMAS may include gamma voltage level interval information. The gamma voltage generator 170 may adjust voltage levels of the gamma voltages GAMMAS, using the information included in the gamma control signal C_GAMMAS.

The storage device 150 may store black data voltage information for each luminance of the input image. Also, the storage device 150 may store white data voltage information for each luminance of the input image.

Also, the storage device 150 may store a lookup table. The lookup table may include a relationship or mapping between grayscale values included in the input image data DATA1 and data voltages. For example, the lookup table may include a selection value for calculating a data voltage corresponding to a specific grayscale value. The data voltage corresponding to the specific grayscale value may be calculated using the selection value. In addition, the calculated data voltage may correspond to any one voltage among voltages generated by dividing the gamma voltages GAMMAS. For example, 1000 or more voltages may be generated by dividing 9 gamma voltages GAMMAS. The data voltage calculated according to the selection value included in the lookup table may correspond to any one voltage among the 1000 or more voltages.

In some embodiments, the lookup table may be set for each of the sub-pixels included in each of the pixels PX. The lookup table may be provided to the data driver 130 through the timing controller 140, and the data driver 130 may generate data voltages corresponding to a specific grayscale value, based on the lookup table (or the selection value).

The storage device 150 may be implemented as a nonvolatile memory device (electrically erasable programmable read-only memory (EEPROM)), but the present disclosure is not limited thereto.

The power supply 160 may receive the adjusted power control signal C_AVDD2 (or second power control signal) from the timing controller 140, and generate the gamma power voltage, based on the adjusted power control signal C_AVDD2. The gamma power voltage AVDD may be supplied to the data driver 130 via the gamma voltage generator 170. In some embodiments, the gamma power voltage AVDD may be supplied directly to the data driver 130.

The adjusted power control signal C_AVDD2 may include the black data voltage information on the luminance of the input image corresponding to the input image data DATA1. Also, the adjusted power control signal C_AVDD2 may include the information on the margin value MARGIN. The power supply 160 may obtain the black data voltage information and the information on the margin value MARGIN from the received adjusted power control signal C_AVDD2. Also, the power supply 160 may determine a voltage level of the gamma power voltage AVDD, using the obtained information.

The voltage level of the gamma power voltage AVDD may vary according to the adjusted power control signal C_AVDD2. More specifically, the voltage level of the gamma power voltage AVDD may correspond to a value obtained by adding the margin value MARGIN to a black data voltage level with respect to the luminance of the input image. When the luminance of the input image is changed, the black data voltage level with respect to the luminance of the input image may be changed. As the black data voltage level with respect to the luminance of the input image is changed under the assumption that the margin value MARGIN is constant, the voltage level of the gamma power voltage AVDD may be changed.

In embodiments of the present disclosure, as the luminance of the input image corresponding to the input image data DATA1 becomes lower (or as the input image becomes an image with a lower luminance), the black data voltage level with respect to the luminance of the input image may be come lower. Therefore, the voltage level of the gamma power voltage AVDD supplied by the power supply 160 may become lower. Accordingly, as compared with when the voltage level of the gamma power voltage AVDD is constant, the power consumption of the power supply 160 can be reduced regardless of the luminance of the input image corresponding to the input image data DATA1.

The gamma voltage generator 170 may receive the gamma control signal C_GAMMAS from the timing controller 140, and adjust the voltage levels of the gamma voltages GAMMAS, based on the gamma control signal C_GAMMAS.

The gamma control signal C_GAMMAS may include the black data voltage information and the white data voltage information on the luminance of the input image corresponding to the input image data DATA1. Also, the gamma control signal C_GAMMAS may include the gamma voltage level interval information. The gamma voltage level interval information may refer to specific voltage steps or intervals between successive gamma voltage levels, which corresponds to different grayscale values. The gamma voltage generator 170 may obtain the black data voltage information and the white data voltage information on the luminance of the input image from the gamma control signal C_GAMMAS. Also, the gamma voltage generator 170 may obtain the gamma voltage level interval information from the gamma control signal C_GAMMAS. The gamma voltage generator 170 may determine the gamma voltages GAMMAS, using the obtained information. A method of determining the gamma voltages GAMMAS is as follows.

A gamma voltage having a highest voltage level among the gamma voltages GAMMAS may be substantially equal to a black data voltage with respect to the luminance of the input image.

A gamma voltage having a lowest voltage level among the gamma voltages GAMMAS may be substantially equal to a white data voltage with respect to the luminance of the input image.

In addition, a voltage level interval having the same magnitude may be present between adjacent gamma voltages. The voltage level interval may be determined by the gamma voltage level interval information included in the gamma control signal C_GAMMAS.

The gamma voltage generator 170 may determine the voltage levels of the gamma voltages GAMMAS as described above, and supply the determined gamma voltages GAMMAS to the data driver 130.

Meanwhile, at least one of the scan driver 120, the data driver 130, the timing controller 140, the power supply 160, and the gamma voltage generator 170 may be formed in the display unit 110, or be implemented as an IC to be connected in a tape carrier page form to the display unit 110. In addition, at least two of the scan driver 120, the data driver 130, the timing controller 140, the power supply 160, and the gamma voltage generator 170 may be implemented together on one IC.

FIG. 2 is a circuit diagram illustrating an example of the pixel included in the display device shown in FIG. 1. The pixels PX shown in FIG. 1 are substantially identical to one another, and therefore, any one pixel PXij connected to an ith scan line SLi and a jth data line DLj is described as an example.

Referring to FIGS. 1 and 2, the pixel PXij may include a light emitting element LED, a first transistor T1 (driving transistor), a second transistor T2, and a storage capacitor Cst.

An anode electrode of the light emitting element LED may be connected to a second electrode of the first transistor T1, and a cathode electrode of the light emitting element LED may be connected to a second power voltage ELVSS. The light emitting element LED may be implemented as an organic light emitting diode. However, the present disclosure is not limited thereto, and the light emitting element LED may be implemented as an inorganic light emitting diode or the like. The light emitting element LED may emit light with a luminance corresponding to an amount of current supplied from the first transistor T1.

A first electrode of the first transistor T1 may be connected to a first power voltage ELVDD, and the second electrode of the first transistor T1 may be connected to the anode electrode of the light emitting element LED. A gate electrode of the first transistor T1 may be connected to a first node N1. The first transistor T1 may control an amount of current flowing through the light emitting element LED, corresponding to a voltage of the first node N1.

A first electrode of the second transistor T2 may be connected to the jth data line DLj, and a second electrode of the second transistor T2 may be connected to the first node N1. A gate electrode of the second transistor T2 may be connected to the ith scan line SLi. The second transistor T2 may be turned on when a scan signal S[n] is supplied to the first scan line SLi, to transfer a data signal DATA from the jth data line DLj to the first node N1.

The storage capacitor Cst may be connected between the first node N1 and the anode electrode of the light emitting element LED. The storage capacitor Cst may store the voltage of the first node N1.

In FIG. 2, it is illustrated that the first transistor T1 and the second transistor T2 is implemented with an N-type transistor. However, this is merely illustrative, and the present disclosure is not limited thereto. For example, the first transistor T1 and the second transistor T2 may be implemented with a P-type transistor. In addition, the circuit structure of the pixel PXij shown in FIG. 2 is merely illustrative, and the pixel PXij is not limited thereto. For example, the pixel PXij may further include a circuit element for measuring an emission characteristic of the light emitting element LED and/or a threshold voltage of the first transistor T1 (e.g., a sensing transistor) connected to a sensing line separate from the anode electrode of the light emitting element LED.

FIG. 3 is a block diagram illustrating the timing controller shown in FIG. 1 according to an embodiment.

Referring to FIGS. 1 and 3, the timing controller 140 may include a storage block 141 (e.g., a memory device) or a signal generator 142.

The storage block 141 may receive the power control signal C_AVDD1 from the storage device 150. Also, the storage block 141 may load, from the power control signal C_AVDD1, the black data voltage information and the white data voltage information with respect to the luminance of the input image corresponding to the input image data DATA1. Also, the storage block 141 may load the lookup table from the storage device 150. As described above, the lookup table may include a relationship or mapping between grayscale values included in the input image data DATA1 and data voltages. For example, the lookup table may include a selection value for calculating a data voltage corresponding to a specific grayscale value. The storage block 141 may be implemented as a nonvolatile memory device or a volatile memory device.

The signal generator 142 may receive the input image data DATA1 from the outside. The signal generator 142 may receive, from the storage device 150, a value of the black data voltage and a value of the white data voltage associated with the luminance of the input image corresponding to the input image data DATA1, using the storage block 141. The signal generator 142 may receive the lookup table from the storage block 141. Also, the signal generator 142 may receive the information on the margin value MARGIN from the outside. The signal generator 142 may receive the control signal CS.

The signal generator 142 may generate the scan control signal SCS, based on the control signal CS, and provide the scan control signal SCS to the scan driver 120. The signal generator 142 may convert the input image data DATA1 into the image data DATA2, and provide the image data DATA2 to the data driver 130. For example, the signal generator 142 may convert the input image data DATA1 in the RGB format into the image data DATA2 in the RGBG format, which accords with the pixel arrangement in the display unit 110, and provide the image data DATA2 to the data driver 130.

The signal generator 142 may generate an adjusted power control signal C_AVDD2 (or second power control signal), and transfer the adjusted power control signal C_AVDD2 to the power supply 160. The adjusted power control signal C_AVDD2 may include the black data voltage information on the luminance of the input image corresponding to the input image data DATA1. Also, the adjusted power control signal C_AVDD2 may include information on the margin value MARGIN. The adjusted power control signal C_AVDD2 may further include the white data voltage information on the luminance of the input image corresponding to the input image data DATA1.

The signal generator 142 may generate the gamma control signal C_GAMMAS, and transfer the gamma control signal C_GAMMAS to the gamma voltage generator 170. The gamma control signal C_GAMMAS may include the black data voltage information and the white data voltage information on the luminance of the input image corresponding to the input image data DATA1. Also, the gamma control signal C_GAMMAS may include the gamma voltage level interval information.

The signal generator 142 may transfer the lookup table transferred from the storage block 141 to the data driver 130.

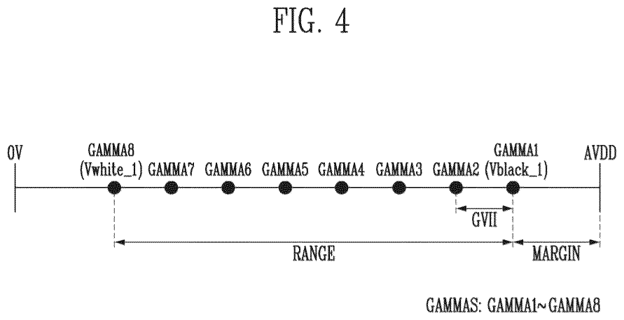

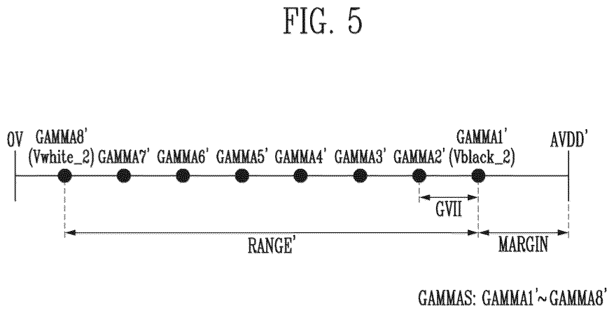

FIGS. 4 and 5 are diagrams illustrating magnitudes of gamma voltages and a gamma power voltage according to a luminance of an input image. FIG. 4 is a case where the luminance of the input image corresponding to the input image data DATA1 (see FIG. 1) is a first luminance, and FIG. 5 is a case where the luminance of the input image is a second luminance smaller than the first luminance.

Referring to FIG. 4, gamma voltages GAMMAS may include first to eighth gamma voltages GAMMA1 to GAMMA8.

The first gamma voltage GAMMA1 may correspond to a black data voltage Vblack_1 associated with the first luminance. In addition, the eighth gamma voltage GAMMA8 may correspond to a white data voltage Vwhite_1 associated with the first luminance.

A voltage level of a gamma power voltage AVDD may correspond to a value obtained by adding a margin value MARGIN to a voltage level of the black data voltage Vblack_1 associated with the first luminance.

In addition, a voltage level interval GVII having the same magnitude may be present between adjacent gamma voltages. For example, the gamma voltages may be spaced apart from one another by the voltage level interval GVII.

Voltages between the first gamma voltage GAMMA1 and the eighth gamma voltage GAMMA8 may become a range RANGE of data voltages DATA generated by the data driver 130.

Referring to FIG. 5, gamma voltages GAMMAS may include first to eighth gamma voltages GAMMA1′ to GAMMA8′.

The first gamma voltage GAMMA1′ may correspond to a black data voltage Vblack_2 associated with the second luminance. In addition, the eighth gamma voltage GAMMA8′ may correspond to a white data voltage Vwhite_2 associated with the second luminance.

A voltage level of a gamma power voltage AVDD′ may correspond to a value obtained by adding the margin value MARGIN to a voltage level of the black data voltage Vblack_2 associated with the second luminance. It is assumed that the margin value MARGIN is equal to the margin value MARGIN when the input image with the first luminance shown in FIG. 4 is input. However, embodiments of the present disclosure are not limited thereto.

In addition, a voltage level interval GVII having the same magnitude may be present between adjacent gamma voltages. It is assumed that the voltage level interval GVII is equal to the voltage level interval GVII when the input image with the first luminance shown in FIG. 4 is input. However, embodiments of the present disclosure are not limited thereto.

Voltages between the first gamma voltage GAMMA1′ and the eighth gamma voltage GAMMA8′ may become a range RANGE′ of data voltages DATA generated by the data driver 130.

Referring to FIGS. 4 and 5, the voltage level of the gamma power voltage AVDD′ when the luminance of the input image is the second luminance may be smaller than the voltage level of the gamma power voltage AVDD when the luminance of the input image is the first luminance.

In other words, in the embodiments of the present disclosure, the voltage level of a gamma power voltage AVDD generated by the power supply 160 becomes low when an input image with a low luminance is input to the display device 100. The gamma power voltage AVDD may be a voltage necessary for driving the data driver 130. The voltage of the gamma power voltage AVDD varies according to the luminance of the input image, so that the power consumption of the display device 100 can be reduced.

FIG. 6 is a block diagram illustrating the data driver shown in FIG. 1 according to an embodiment.

Referring to FIGS. 1 and 6, the data driver 130 includes a decoder 131 (or digital-to-analog converter (DAC)) and an output buffer 132. The data driver 130 may further include a shift register, a latch, and the like.

The decoder 131 may generate a data signal DATA corresponding to a grayscale value in the image data DATA2, based on the lookup table, and the black data voltage information and the white data voltage information on the luminance of the input image.

The lookup table, and the black data voltage information and the white data voltage information on the luminance of the input image may be provided from the timing controller 140. The decoder 131 may detect a voltage level of a black data voltage with respect to the luminance of the input image from the black data voltage information on the luminance of the input image. Also, the decoder 131 may detect a voltage level of a white data voltage with respect to the luminance of the input image from the white data voltage information on the luminance of the input image.

The lookup table may include a relationship between grayscale values included in the image data DATA2 (or the input image data DATA1) and data voltages. For example, the lookup table may include a selection value for calculating a data voltage corresponding to a specific grayscale value. The data voltage corresponding to the specific grayscale value may be calculated using the selection value.

A detailed calculation formula of the data voltage is as follows.

First, in accordance with an embodiment of the present disclosure, the decoder 131 may calculate a voltage level of a data voltage (or data signal) DATA according to a calculation formula of Vblack−GLUT×(Vblack−Vwhite)/GLUT_MAX.

Vblack may correspond to a voltage level of the black data voltage associated with the luminance of the input image. GLUT may be a selection value corresponding to a specific grayscale value, and the selection value may be obtained through the lookup table. Vwhite may correspond to a voltage level of the white data voltage with respect to the luminance of the input image. In addition, GLUT_MAX may correspond to a greatest value among selection values. Since GLUT corresponds to a number of 0 or more and 1 or less, GLUT_MAX may correspond to 1.

For example, when the decoder 131 is to supply the black data voltage as the data voltage DATA to the display unit 110, it may determine GLUT to be the selection value of 0 from the lookup table, and the voltage level of the data voltage DATA may become Vblack according to the calculation formula.

For example, when the decoder 131 is to supply the white data voltage as the data voltage DATA to the display unit 110, it may determine GLUT to be the selection value of 1 from the lookup table, and the voltage level of the data voltage DATA may become Vwhite according to the calculation formula.

By varying the selection value in this manner, a voltage level of the data voltage DATA may be calculated with respect to various grayscale values included in the input image.

In addition, a voltage having the calculated voltage level among voltages generated by dividing gamma voltages GAMMAS may be selected as the data voltage DATA.

In the embodiment of the present disclosure, when the luminance of the input image varies, the voltage level of the gamma power voltage AVDD, the voltage level of the black data voltage, and the voltage level of the white data voltage may vary. When the voltage level of the data voltage DATA is calculated according to the above-described calculation formula, the same selection value may be used to express an input image having the same grayscale even though the luminance of the input image varies. For example, irrespective of variations in the luminance of the input image, the selection value corresponding to a same grayscale value remains unchanged. In other words, in order to express the input image having the same grayscale, it is unnecessary to store different selection values in the lookup table for every luminance of the input image. For example, although the luminance of the input image varies, the selection value may be the same as 0 so as to allow the voltage level of the data voltage DATA to become Vblack. Accordingly, a data voltage having a desired grayscale can be prevented from not being generated due to an unintended change in selection value when the luminance of the input image varies.

Next, in accordance with another embodiment of the present disclosure, the decoder 131 may calculate a data voltage (or data signal DATA) according to a calculation formula of Vwhite+GLUT×(Vblack−Vwhite)/GLUT_MAX. In an embodiment, when GLUT_MAX is 1, the calculation formula simplifies to Vwhite+GLUT×(Vblack−Vwhite).

Vblack may correspond to a voltage level of the black data voltage associated with the luminance of the input image. GLUT may be a selection value corresponding to a specific grayscale value, and the selection value may be obtained through the lookup table. Vwhite may correspond to a voltage level of the white data voltage associated with the luminance of the input image. In addition, GLUT_MAX may correspond to a greatest value among selection values. Since GLUT corresponds to a number of 0 or more and 1 or less, GLUT_MAX may correspond to 1.

For example, when the decoder 131 is to supply the black data voltage as the data voltage DATA to the display unit 110, it may determine GLUT to be the selection value of 1 from the lookup table, and the voltage level of the data voltage DATA may become Vblack according to the calculation formula.

For example, when the decoder 131 is to supply the white data voltage as the data voltage DATA to the display unit 110, it determine GLUT to be the selection value of 0 from the lookup table, and the voltage level of the data voltage DATA may become Vwhite according to the calculation formula.

By varying the selection value in this manner, a voltage level of the data voltage DATA may be calculated with respect to various grayscale values included in the input image.

In addition, a voltage having the calculated voltage level among voltages generated by dividing gamma voltages GAMMAS may be selected as the data voltage DATA.

In this embodiment of the present disclosure, when the luminance of the input image varies, the voltage level of the gamma power voltage AVDD, the voltage level of the black data voltage, and the voltage level of the white data voltage may vary. When the voltage level of the data voltage DATA is calculated according to the above-described calculation formula, the same selection value may be used to express an input image having the same grayscale even though the luminance of the input image varies. In other words, in order to express the input image having the same grayscale, it is unnecessary to store different selection values in the lookup table for every luminance of the input image. For example, although the luminance of the input image varies, the selection value may be the same as 1 so as to allow the voltage level of the data voltage DATA to become Vblack. Accordingly, a data voltage having a desired grayscale can be prevented from not being generated due to an unintended change in selection value when the luminance of the input image varies.

The output buffer 132 may provide the data signal (or data voltage) DATA to the display unit 110 (or the pixels PX).

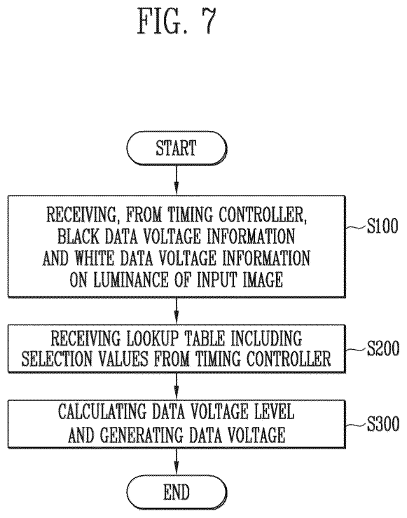

FIG. 7 is a flowchart illustrating a driving method of the display device shown in FIG. 1 according to an embodiment.

Referring to FIGS. 1 to 7, in step S100, the data driver 130 receives, from the timing controller 140, black data voltage information and white data voltage information on a luminance of an input image corresponding to input image data DATA1.

The storage device 150 may store black data voltage information for each luminance of the input image. Also, the storage device 150 may store white data voltage information for each luminance of the input image.

In addition, the black data voltage information and the white data voltage information on the luminance of the input image corresponding to the input image data DATA1 may be transferred to the data driver 130 via the timing controller 140 from the storage device 150.

In step S200, the data driver 130 receives a lookup table including selection values from the timing controller 140.

The storage device 150 may store the lookup table. The lookup table may include a relationship or mapping between grayscale values included in image data DATA2 (or the input image data DATA1) and data voltages. For example, the lookup table may include a selection value for calculating a data voltage corresponding to a specific grayscale value. The data voltage corresponding to the specific grayscale value may be calculated using the selection value.

The lookup table may be transferred to the data driver 130 via the timing controller 140 from the storage device 150.

In step S300, the data driver 130 calculates a data voltage level with respect to a specific grayscale, based on the received information (e.g., the black data voltage information and the white data voltage information on the luminance of the input image, and the lookup table), and generates a data voltage based on the calculated data voltage level.

In accordance with an embodiment of the present disclosure, the data driver 130 (or the decoder 131) may calculate a voltage level of a data voltage (or data signal) DATA according to a calculation formula of Vblack−GLUT×(Vblack−Vwhite)/GLUT_MAX. In an embodiment, when GLUT_MAX is 1, the calculation formula simplifies to Vblack−GLUT×(Vblack−Vwhite).

Vblack may correspond to a voltage level of the black data voltage associated with the luminance of the input image. GLUT may be a selection value corresponding to a specific grayscale value, and the selection value may be obtained through the lookup table. Vwhite may correspond to a voltage level of the white data voltage associated with the luminance of the input image. In addition, GLUT_MAX may correspond to a greatest value among selection values. Since GLUT corresponds to a number of 0 or more and 1 or less, GLUT_MAX may correspond to 1.

For example, when the decoder 131 is to supply the black data voltage as the data voltage DATA to the display unit 110, it may determine GLUT to be the section value of 0 from the lookup table, and the voltage level of the data voltage DATA may become Vblack according to the calculation formula.

For example, when the decoder 131 is to supply the white data voltage as the data voltage DATA to the display unit 110, it may determine GLUT to be the selection value of 1 from the lookup table, and the voltage level of the data voltage DATA may become Vwhite according to the calculation formula.

By varying the selection value in this manner, a voltage level of

the data voltage DATA may be calculated with respect to various grayscale values included in the input image.

In addition, a voltage having the calculated voltage level among voltages generated by dividing gamma voltages GAMMAS may be selected as the data voltage DATA.

In the embodiment of the present disclosure, when the luminance of the input image varies, the voltage level of the gamma power voltage AVDD, the voltage level of the black data voltage, and the voltage level of the white data voltage may vary. When the voltage level of the data voltage DATA is calculated according to the above-described calculation formula, the same selection value may be used to express an input image having the same grayscale even though the luminance of the input image varies. In other words, in order to express the input image having the same grayscale, it is unnecessary to store different selection values in the lookup table for every luminance of the input image. For example, although the luminance of the input image varies, the selection value may be the same as 0 so as to allow the voltage level of the data voltage DATA to become Vblack. Accordingly, a data voltage having a desired grayscale can be prevented from not being generated due to an unintended change in selection value when the luminance of the input image varies.

In accordance with an embodiment of the present disclosure, the data driver 130 (or the decoder 131) may calculate a data voltage (or data signal DATA) according to a calculation formula of Vwhite+GLUT×(Vblack−Vwhite)/GLUT_MAX.

Vblack may correspond to a voltage level of the black data voltage associated with the luminance of the input image. GLUT may be a selection value corresponding to a specific grayscale value, and the selection value may be obtained through the lookup table. Vwhite may correspond to a voltage level of the white data voltage associated with the luminance of the input image. In addition, GLUT_MAX may correspond to a greatest value among selection values. Since GLUT corresponds to a number of 0 or more and 1 or less, GLUT_MAX may correspond to 1.

For example, when the decoder 131 is to supply the black data voltage as the data voltage DATA to the display unit 110, it may determine GLUT to be the selection value of 1 from the lookup table, and the voltage level of the data voltage DATA may become Vblack according to the calculation formula.

For example, when the decoder 131 is to supply the white data voltage as the data voltage DATA to the display unit 110, it may determine GLUT to be the selection value of 0 from the lookup table, and the voltage level of the data voltage DATA may become Vwhite according to the calculation formula.

By varying the selection value in this manner, a voltage level of the data voltage DATA may be calculated with respect to various grayscale values included in the input image.

In addition, a voltage having the calculated voltage level among voltages generated by dividing gamma voltages GAMMAS may be selected as the data voltage DATA.

In this embodiment of the present disclosure, when the luminance of the input image varies, the voltage level of the gamma power voltage AVDD, the voltage level of the black data voltage, and the voltage level of the white data voltage may vary. When the voltage level of the data voltage DATA is calculated according to the above-described calculation formula, the same selection value may be used to express an input image having the same grayscale even though the luminance of the input image varies. In other words, in order to express the input image having the same grayscale, it is unnecessary to store different selection values in the lookup table for every luminance of the input image. For example, although the luminance of the input image varies, the selection value may be the same as 1 so as to allow the voltage level of the data voltage DATA to become Vblack. Accordingly, a data voltage having a desired grayscale can be prevented from not being generated due to an unintended change in selection value when the luminance of the input image varies.

In accordance with at least one embodiment of the present disclosure, a display device and a driving method thereof are provided, in which power consumption can be reduced by varying the magnitude of a voltage applied to a data driver according to a luminance of an input image.

A display device according to an embodiment is applicable to various types of electronic devices. In an embodiment, an electronic device includes the above-described display device and may further include other modules or devices having additional functions in addition to the display device.

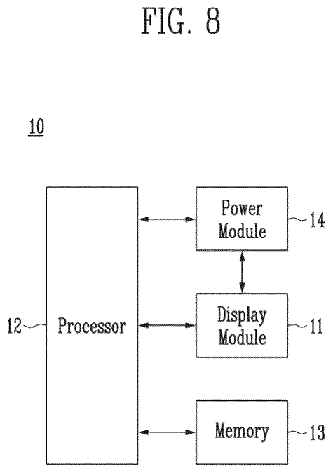

FIG. 8 is a block diagram of an electronic device according to an embodiment. Referring to FIG. 8, the electronic device 10 may include a display module 11, a processor 12, a memory 13, and a power module 14.

The processor 12 may include at least one of a central processing unit (CPU), an application processor (AP), a graphic processing unit (GPU), a communication processor (CP), an image signal processor (ISP), and a controller.

The memory 13 may store data and/or information used to operate the processor 12 or the display module 11. When the processor 12 executes an application stored in the memory 13, image data signals and/or input control signals may be transferred to the display module 11. The display module 11 may process the provided signals and output image information on a display screen.

The power module 14 may include a power supply module, such as a power adapter or a battery device, and a power conversion module. The power conversion module converts power supplied by the power supply module and generates power to operate the electronic device 10.

At least one of the above-described components of the electronic device 10 may be included in the display device according to embodiments as described above. In addition, in terms of functionality, some of the individual modules included in one module may be included in the display device and others may be provided separately from the display device. For example, the display module 11 is included in the display device, whereas the processor 12, the memory 13, and the power module 14 are not included in the display device and are instead provided separately in the electronic device 10.

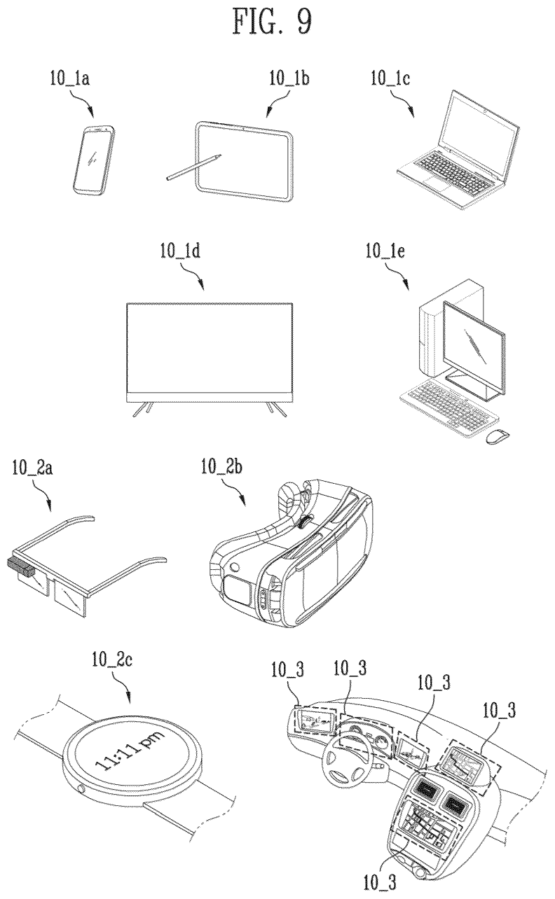

FIG. 9 shows schematic views of various embodiments of an electronic device.

Referring to FIG. 9, various types of electronic devices to which embodiments of a display device are applied may include an electronic device to display images such as a smartphone 10_1a, a tablet PC 10_1b, a laptop computer 10_1c, a television (TV) 10_1d, and a desktop monitor 10_1e, a wearable electronic device including a display module such as smart glasses 10_2a, a head-mounted display (HMD) 10_2b, and a smart watch 10_2c, and an automotive electronic device 10_3 including a display module such as a center information display (CID) disposed at the instrument cluster, the center fascia, and the dashboard of a vehicle, and a room mirror display.

Example embodiments have been disclosed herein, and although specific terms are employed, they are used and are to be interpreted in a generic and descriptive sense only and not for purpose of limitation. In some instances, as would be apparent to one of ordinary skill in the art at the time of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present disclosure.

What is claimed is:

1. A display device comprising:
a display unit including pixels;
a power supply configured to generate a gamma power voltage, based on a power control signal;
a gamma voltage generator configured to generate gamma voltages, based on a gamma control signal; and
a data driver configured to generate a data voltage corresponding to a grayscale value included in image data, using the gamma voltages, and provide the data voltage to the pixels,
wherein a voltage level of the gamma power voltage varies according to a luminance of an input image corresponding to the image data.

2. The display device of claim 1, wherein the voltage level of the gamma power voltage becomes lower as the luminance of the input image becomes lower.

3. The display device of claim 1, further comprising:
a storage device configured to store black data voltage information and white data voltage information for each luminance of the input image; and
a timing controller configured to receive, from the storage device, the black data voltage information and the white data voltage information on the luminance of the input image to generate the power control signal and the gamma control signal.

4. The display device of claim 3, wherein the power control signal includes the black data voltage information on the luminance and information on a margin value, and
wherein the power supply determines the voltage level of the gamma power voltage by adding the margin value to a black data voltage level obtained from the black data voltage information on the luminance.

5. The display device of claim 4, wherein the gamma power voltage is a voltage necessary for driving the data driver, and is supplied to the data driver via the gamma voltage generator.

6. The display device of claim 3, wherein the gamma control signal includes the black data voltage information and the white data voltage information on the luminance,
wherein the gamma voltage generator determines a black data voltage level obtained from the black data voltage information on the luminance as a voltage level of a first gamma voltage among the gamma voltages, and
wherein the gamma voltage generator determines a white data voltage level obtained from the white data voltage information on the luminance as a voltage level of a second gamma voltage among the gamma voltages.

7. The display device of claim 6, wherein the first gamma voltage corresponds to a voltage having a highest voltage level among the gamma voltages, and
the second gamma voltage corresponds to a voltage having a lowest voltage level among the gamma voltages, and
wherein the data voltage is selected among voltages generated by dividing the gamma voltages.

8. The display device of claim 3, wherein the data driver receives, from the storage device, a lookup table including a selection value for calculating a data voltage corresponding to a specific grayscale value, and calculates a voltage level of the data voltage, using the selection value, and
wherein, irrespective of variations in the luminance of the input image, the selection value for calculating the data voltage corresponding to a same grayscale value remains unchanged.

9. The display device of claim 8, wherein the data voltage becomes a black data voltage when the selection value is 0, and becomes a white data voltage when the selection value is 1.

10. The display device of claim 8, wherein the data voltage becomes a black data voltage when the selection value is 1, and becomes a white data voltage when the selection value is 0.

11. A method of driving a display device, the method comprising:
receiving, from a timing controller, black data voltage information and white data voltage information on a luminance of an input image;
receiving a lookup table from the timing controller that includes selection values mapped to corresponding grayscales; and
calculating a data voltage level, based on the received black data voltage information, the received white data voltage information, and a selection value among the selection values mapped to one of the grayscales of the input image,
wherein irrespective of variations in the luminance of the input image, the selection value corresponding to a same grayscale value remains unchanged.

12. The method of claim 11, wherein a data voltage generated from the data voltage level becomes a black data voltage when the selection value is 0, and becomes a white data voltage when the selection value is 1.

13. The method of claim 11, wherein a data voltage generated from the data voltage level becomes a black data voltage when the selection value is 1, and becomes a white data voltage when the selection value is 0.

14. The method of claim 11, wherein the display device includes a storage device configured to store black data voltage information and white data voltage information for each luminance of the input image, and the lookup table, and
wherein the method further comprises receiving, by the timing controller, the black data voltage information and the white data voltage information on the luminance of the input image, and the lookup table from the storage device.

15. The method of claim 11, wherein the display device includes a power supply configured to generate a gamma power voltage, based on a power control signal generated by the timing controller, and
wherein a voltage level of the gamma power voltage varies according to the luminance of the input image.

16. The method of claim 15, wherein the voltage level of the gamma power voltage becomes lower as the luminance of the input image becomes lower.

17. An electronic device, comprising:
a processor to provide input image data; and
a display device to display an image based on the input image data,
the display device comprising:
a display unit including pixels;
a timing controller; and
a data driver configured to:
receive black data voltage information and white data voltage information corresponding to a luminance of an input image,
receive a lookup table from the timing controller including selection values corresponding to respective grayscales; and
calculate a data voltage level based on the received black data voltage information, the received white data voltage information, and a selection value from the lookup table corresponding to a grayscale in the input image.

18. The electronic device of claim 17, wherein the data driver calculates a data voltage based on the data voltage level and applies the data voltage to a data line connected to the pixels.

19. The electronic device of claim 17, wherein the data voltage level is V_{black}+GLUT×(V_{white}−V_{black}), where V_{black} is a black data voltage derived from the received black data voltage information, V_{white} is a white data voltage device from the received white data voltage information and GLUT is the selection value.

20. The electronic device of claim 17, wherein the data voltage level is V_{white}+GLUT×(V_{black}−V_{white}), where V_{black} is a black data voltage derived from the received black data voltage information, V_{white} is a white data voltage device from the received white data voltage information and GLUT is the selection value.
